(19) United States
(12) Patent Application Publication
(10) Pub. No.: US 2026/0189158 A1
(43) Pub. Date: Jul. 2, 2026

(54) METHOD FOR OPERATING AN INVERTER COMPRISING AN H4 BRIDGE CIRCUIT WITH MODIFIED UNIPOLAR CLOCKING

(71) Applicant: SMA Solar Technology AG, Niestetal (DE)

(72) Inventor: Stefan Engel, Kaufungen (DE)

(21) Appl. No.: 19/464,717

(22) Filed: Jan. 30, 2026

Related U.S. Application Data
(63) Continuation of application No. PCT/EP2024/072328, filed on Aug. 7, 2024.

(30) Foreign Application Priority Data
Aug. 7, 2023 (DE) 10 2023 120 963.9

(51) Int. Cl. H02M 7/5387; H02J 3/38; H02J 101/24; H02M 1/44

(52) U.S. Cl. CPC H02M 7/53871; H02J 3/38; H02M 1/44; H02J 2101/24

(57) ABSTRACT

The application relates to a method for operating an inverter that has an H4 bridge circuit having a first half-bridge and a second half-bridge for converting an input-side direct voltage into an output-side alternating voltage and is configured for supplying electrical power of a direct voltage source with a variable potential relative to a ground potential, for example, of a photovoltaic generator with a leakage capacitance with respect to ground, to an alternating voltage grid. The method includes unipolar pulse-width-modulated clocking for each of the two half-bridges for the half-wave generation of substantially sinusoidal half-bridge voltages, and modifying the clocking of the half-bridges in a transition region around a zero crossing of the output-side alternating voltage to damp a leakage current (IA) that flows through the leakage capacitor to ground. The application also relates to an inverter and to a computer program product.

### REFERENCE TO RELATED APPLICATIONS

This application is a Continuation of International Application number PCT/EP2024/072328, filed on Aug. 7, 2024, which claims the benefit of German Application number 10 2023 120 963.9, filed on Aug. 7, 2023. The contents of the above-referenced Patent Applications are hereby incorporated by reference in their entirety.

### FIELD

The application relates to a method for operating an inverter with an H4 bridge circuit and an inverter with an H4 bridge circuit. The H4 bridge circuit comprises an arrangement of semiconductor switches in two half-bridges, each with two switches, and is configured to convert a direct voltage to an alternating voltage by clocked switching of the semiconductor switches.

### BACKGROUND

When connecting a photovoltaic generator (PV generator) to an alternating voltage grid (AC grid) via a power electronic inverter, the individual phase conductors of the alternating voltage grid as well as the PV generator have a potential position relative to ground potential. If no galvanic isolation and in particular no transformer is provided between the PV generator and the AC grid, the clocked switching of the inverter bridge circuit directly or indirectly will influence the potential position of the PV generator with respect to ground. The dynamic conversion of the direct current voltage of the PV generator into an alternating voltage for the grid by dynamically clocking the inverter usually results in a periodically changing potential position of the PV generator with respect to the ground potential.

Due to its design, a PV generator is linked to ground potential via a leakage capacitor and a leakage resistor, wherein their specific values, in particular of the leakage capacitor, are largely determined by the specific electromechanical design of the PV generator as well as by other environmental conditions such as humidity. Depending on the specific leakage capacitance and the specific clocking scheme used for the switches of the inverter to generate an alternating voltage at its output, a periodic change in the potential position of the PV generator may result during operation which can lead to leakage currents flowing between PV generator and ground that are disadvantageous or even unacceptably high.

In EP 2 136 465 B1, an inverter is described for supplying power from a direct voltage source, in particular a photovoltaic generator, to an alternating voltage grid. The inverter has an asymmetrically clocked bridge circuit, wherein at least two switches are clocked at grid frequency and at least two further switches are clocked at a higher clock frequency.

In JP 3 316 735 B2, an inverter for supplying power from a photovoltaic generator to an alternating voltage grid is described, wherein the inverter is operated with a unipolar clocking.

In CN 202565189 U, a method is described for operating an inverter in which the inverter is in principle clocked in a unipolar manner and, in the region around the zero crossings of the alternating voltage, is clocked in a bipolar manner.

### SUMMARY

The application is directed to improving the power conversion by the inverter and, in particular, reducing the leakage currents between a PV generator or other direct current source and ground potential.

An inverter comprises an H4 bridge circuit having a first half-bridge and a second half-bridge for converting an input-side direct voltage into an output-side alternating voltage. The inverter is configured to exchange electrical power between a direct voltage source and an alternating voltage grid. The direct voltage source has a variable potential relative to ground potential via a leakage capacitance. The inverter can, for example, be configured to draw electrical power from a photovoltaic generator having a leakage capacitance between the PV modules and ground potential, and feed electric power to an alternating voltage grid.

A method for operating the inverter comprises:
unipolar pulse-width-modulated clocking of one of the two half-bridges, respectively, in each half-wave of the output-side alternating voltage for half-wave generation of essentially sinusoidal half-bridge voltages; and
modifying the clocking of the half-bridges in a transition region around a zero crossing of the output-side alternating voltage in order to damp a leakage current that flows through the leakage capacitor to ground.

The method is suitable for damping oscillations of leakage currents that flow in a resonant circuit comprising the leakage capacitor of the direct voltage source and common-mode inductors of the inverter.

Due to the respective unipolar pulse-width-modulated clocking for each of the two half-bridges in each half-wave of the alternating output voltage for the half-wave generation of the essentially sinusoidal half-bridge voltages, one half-bridge is used to generate the positive half-wave of the output-side alternating voltage and the other half-bridge is used to generate the negative half-wave of the output-side alternating voltage. By means of the pulse width of a cycle, i.e. the relative width of a switch-on or switch-off phase of the bridge switches within a cycle, the respective half-bridge voltage for the respective cycle is set. The respective half-bridge voltage of the respective clocked half-bridge is thus directly related to the current pulse width. The half-bridges are clocked using the pulse width, which determines the switched, i.e. conductive, state of the respective switches of the respective half-bridge. The two switches of the respective half-bridge can be switched in an opposing manner, i.e. if one of the switches is open, the other is closed. The pulse width of the respective clocking follows the desired half-bridge voltage, which in the case of unipolar clocking follows the profile of the desired output voltage of the inverter.

With conventional, exclusively unipolar clocking during each half-wave, one half-bridge is used to generate the entire respective half-wave of the alternating output voltage; i.e. one half-bridge generates one half-wave of the output voltage, while the other half-bridge is inactive, i.e. not clocked, and generates a half-bridge voltage of zero. During the other half-wave, the first half-bridge is inactive and the other half-bridge generates the second half-wave of the inverter's output voltage.

In the transition region around the zero crossing of the alternating output voltage, the clock pattern according to the application deviates from the exclusively unipolar clocking comprising only one clocked half-bridge. The clock patterns of the half-bridges are modified in such a way that the leakage current flowing through the leakage capacitor of the PV generator is damped. Damping can mean, for example, that the leakage current is reduced in magnitude and/or oscillations are reduced so that current peaks in the leakage current are reduced. The clocking modification is carried out in such a way that, in the transition region compared to the exclusively unipolar clocking, modified half-bridge voltages are generated by the modified clocking, which excite a reduced leakage current to ground. In one embodiment, this reduces effects in the time profile of the potential of the PV generator with respect to the ground potential, which can occur abruptly around the zero crossing of the alternating output voltage and generate current peaks in the leakage current when using exclusively unipolar clocking.

The transition region can be, for example, symmetrical around the zero crossing of the output-side alternating voltage over time so that the zero crossing is located in the middle of the transition region according to one embodiment.

By means of the described method, excitation and oscillation of the leakage current at or after the zero crossing of the output-side alternating voltage can be damped. In one embodiment, by modifying the clocking in the transition region, a leakage current can be reduced which otherwise may be caused by a sudden change in the slope of the half-bridge voltages and thus of the potential position of the PV generator at the zero crossing. This damps the sudden recharging of the leakage capacitor at the zero crossing and reduces the excitation of resonance as well as an oscillation of the leakage current.

In one embodiment of the method, the first half-bridge and the second half-bridge can be concurrently pulse-width-modulated in the transition region before and after the zero crossing of the alternating output voltage. This can reduce the change in the slope of the half-bridge voltages and therefore the potential position of the PV generator at the zero crossing of the alternating output voltage.

In one embodiment of the method, the half-bridge voltages for the first and second half-bridge deviate from the otherwise half-wave sinusoidal shape due to the concurrent clocking of the half-bridges in the transition region. In this case, the half-bridge voltages of the half-bridges in the transition region vary in opposite directions to each other and, for example, mirror-symmetrically to each other with respect to the time of the zero crossing of the alternating output voltage. This reduces the change in the slope of the half-bridge voltages and therefore the potential position of the PV generator, and at the same time, the desired sinusoidal shape of the alternating output voltage of the inverter is maintained.

In one embodiment of the method, the transition region comprises a time span of +/−0.02-1.0 milliseconds, for example, +/−0.1-0.5 milliseconds around the zero crossing of the alternating output voltage. During this period around the zero crossing of the alternating output voltage, the steepest slopes of the half-bridge voltages and therefore the highest leakage currents occur with typical leakage capacitors, wherein by means of the method, not only a reduction in the amplitude of the leakage current but also a damping of the oscillations of the leakage current is achieved. The transition region can comprise up to one tenth of the period of the alternating voltage in the alternating voltage grid. Depending on the leakage capacitor, good damping of the oscillations of the leakage current can be achieved in such a transition region.

In one embodiment of the method, the unipolar pulse-width-modulated clocking of a respective half-wave in the transition region is modified such that the respective half-bridge voltage has a profile whose slope is less than the slope of the ideal sinusoidal profile and which is, in one embodiment, linear. Due to the shallower slope, the rate of change of the potential position of the PV generator with respect to the ground potential can be decreased so that the excitation of the leakage current can be reduced and good damping can be achieved.

In some embodiments, the sum of the absolute values of the half-bridge voltages in the transition region can have a constant value. This allows the modified clocking to be integrated particularly well into the control of the inverter in that by appropriately adjusting the width of the transition region, an oscillation of a specific resonant circuit comprising a leakage capacitor of a given direct voltage source and the common-mode inductor of the filters in the inverter can be prevented. The ideal width of the transition region is approximately half the period of a resonant oscillation of this resonant circuit.

In embodiments, the sum of the absolute values of the half-bridge voltages in the transition region can have a form that is approximated by a polynomial. This can further reduce the rate of change of the potential position of the PV generator with respect to the ground potential so that the damping can be further improved.

The inverter for exchanging power between the direct voltage source, for example, the photovoltaic generator, and the alternating voltage grid has a control unit or circuit and an H4 bridge circuit with a first and a second half-bridge. The system is configured to carry out the described method.

The inverter thus modifies the clocking in the transition region around the zero crossing of the output-side alternating voltage compared to an exclusively unipolar clocking, so that, compared to an inverter with exclusively unipolar clocking at the zero crossing of the alternating output voltage, a smoothing of the time profile of the potential of the PV generator with respect to the ground potential is achieved. This serves to reduce the leakage current peak occurring at the zero crossing of the alternating output voltage. The modification of the clocking can, in one embodiment, comprise a profile of the clocking, i.e. the pulse width modulation, that follows a different function in the transition region than outside the transition region.

A non-transitory computer readable medium product contains instructions which, when executed by the control unit, cause it to carry out the described method.

### BRIEF DESCRIPTION OF THE FIGURES

The disclosure is further explained and described below with reference to example embodiments illustrated in the figures.

FIG. 1 schematically shows an inverter with an H4 bridge circuit.

FIG. 2 shows time profiles of half-bridge voltages, duty cycles and switching signals for the half-bridges of an H4 bridge circuit.

FIG. 3 shows examples of values for the sum of the half-bridge voltages.

FIG. 4 shows by way of example an undamped and a damped leakage current.

FIG. 5 shows by way of example a comparison of conventional and modified clocking according to the application with respective associated leakage currents.

FIG. 6 schematically shows a further embodiment of an inverter.

The same reference signs are used in the figures for identical or similar elements. The representations in the figures may not be to scale.

### DETAILED DESCRIPTION

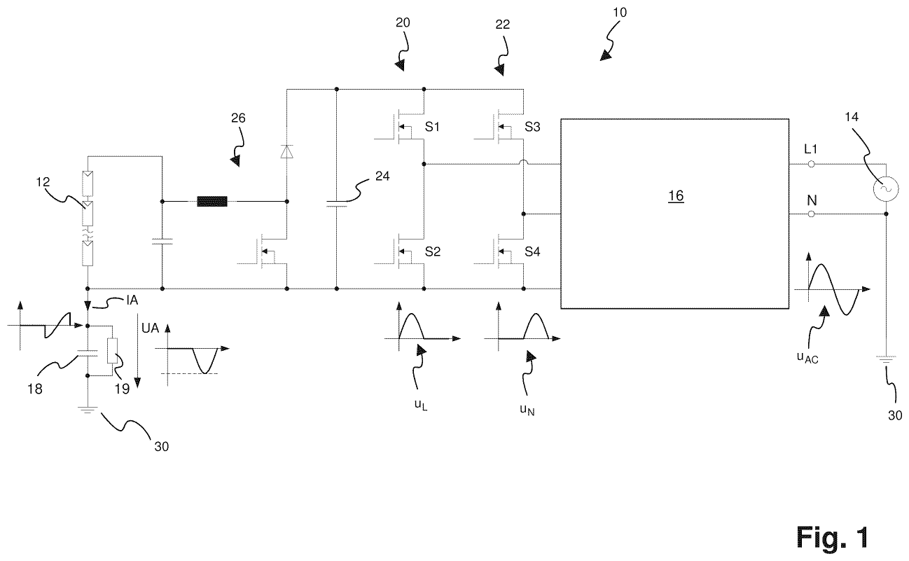

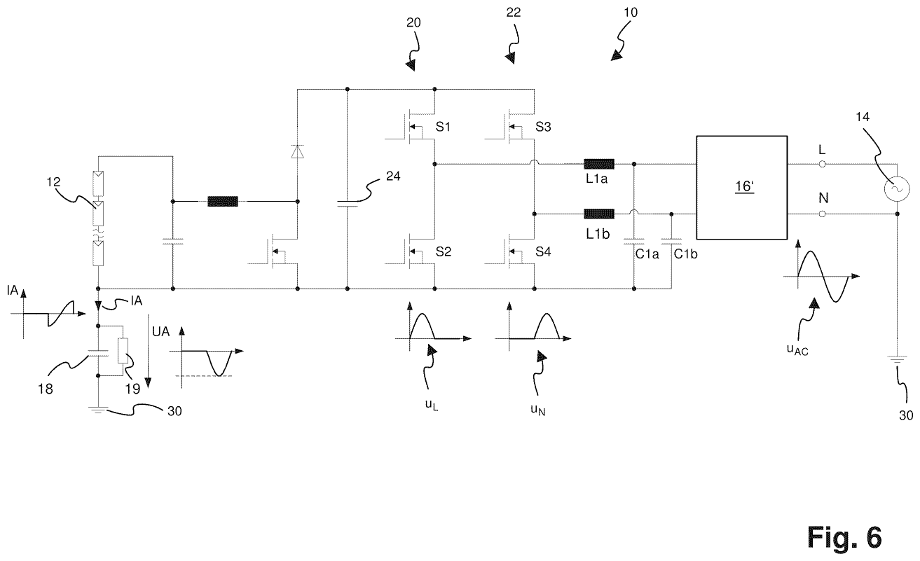

FIG. 1 shows an inverter 10 with an H4 bridge circuit comprising a first half-bridge 20 and a second half-bridge 22. The inverter 10 converts electrical power from a direct voltage source, e.g. a photovoltaic generator 12, to an alternating voltage, such that the electric power is interchangeable with an alternating voltage grid 14, and/or vice versa. In the illustrated example embodiment, an optional DC/DC converter 26 is arranged between the PV generator 12 and the H4 bridge circuit 22, 24, and one-phase alternating voltage u_{AC} is generated so that a one-phase alternating current is exchanged with the alternating voltage grid 14 via a feed-in network 16. Details of the feed-in network 16 are explained in connection with FIG. 6.

The connection to the alternating voltage grid 14 is made via a phase conductor L and a neutral conductor N. The alternating voltage grid is referred to ground potential 30, in particular via the neutral conductor N. The reference of the neutral conductor N to ground potential can be direct, for example, by grounding the neutral conductor, or indirect, for example in a split-phase grid or other grid configurations (e.g. delta corner ground, stinger ground).

On its DC side, the inverter 10 has an intermediate circuit 24. For the exchange of alternating current with an alternating voltage grid 14 with e.g. 230 V nominal voltage and Û=325 V peak voltage, the intermediate circuit 24 can e.g. be designed as a 600 V intermediate circuit in one embodiment.

The direct voltage source comprises, for example, a photovoltaic generator 12 which in turn can comprise a plurality of PV modules connected in series and/or parallel. The direct voltage source is linked to ground potential 30 via a leakage path, e.g. a distributed leakage capacities of the PV modules of the photovoltaic generator 12. The reference to the ground potential 30 is largely predetermined for the photovoltaic generator 12 by its design and can be represented, for example, by a leakage capacitor 18 with a parallel-connected leakage resistor 19. In one embodiment, the leakage capacitance 18 can vary over time and fundamentally change, e.g. depending on climatic conditions during the operation of the direct voltage source such as moisture between PV modules and earth.

The first half-bridge 20 has a first switch S1 and a second switch S2. The second half-bridge 22 has a third switch S3 and a fourth switch S4. To convert the DC-side direct voltage into the AC-side alternating voltage u_{AC} and/or vice versa, the inverter 10 is generally clocked in a unipolar manner. During one half-wave of the output-side alternating voltage u_{AC}, in each case only one of the two half-bridges 20, 22 sets the AC-side alternating voltage u_{AC} by controlling their respective switches in a complementary manner with a sinusoidally pulse-width-modulated duty cycle at a clock frequency of a few kilohertz. In the respective half-bridge that is not clocked, one of the two switches of this half-bridge is permanently switched on in the respective half-wave.

The output-side alternating voltage u_{AC} as needed for exchanging an alternating current with the alternating voltage grid 14 is formed from the two half-bridge voltages u_{L}, u_{N}, wherein the first half-bridge voltage u_{L} sets the positive half-wave of the output alternating voltage u_{AC}, and the second half-bridge voltage u_{N} sets the negative half-wave of the output alternating voltage u_{AC}. The voltage profile of the first half-bridge voltage u_{L} at the first half-bridge 20 is shown by way of example in FIG. 1. The first half-bridge voltage u_{L} corresponds to the profile of one half-wave of a sinusoidal voltage profile. The voltage profile of the second half-bridge voltage u_{N} at the second half-bridge 22 is shown by way of example in FIG. 1. The second half-bridge voltage u_{N} corresponds to the profile of the other half-wave of a sinusoidal voltage profile. The voltage profile of the output-side alternating voltage u_{AC}=u_{L}−u_{N} is shown by way of example in FIG. 1.

Due to the respective reference of the alternating voltage grid 14 and of the PV generator 12 to the ground potential 30, a leakage current IA results which is exchanged between the DC power source 12 and ground potential 30, i.e. flows from the PV generator 12 via the leakage capacitor 18 to ground. The leakage current IA is driven by the leakage voltage UA, the time profile of which is determined by the specific clocking of the inverter 10.

The profile of the leakage voltage UA when using a purely unipolar clocking is shown in FIG. 1 as an example, wherein each half-wave is generated completely and exclusively by clocking a respective half-bridge. In this configuration, the leakage voltage UA follows the profile of the half-bridge voltage u_{N} which is generated by the pulse-width-modulated clocking of the second half-bridge 22 on the AC side. This correspondingly results in a leakage current IA, the profile of which is shown by way of example in FIG. 1. The leakage current IA has a pronounced maxima, for example, at the zero crossings of the output-side alternating voltage u_{AC}, which are mainly caused by charge reversals of the leakage capacitor 18 during the sign change of the alternating voltage u_{AC}.

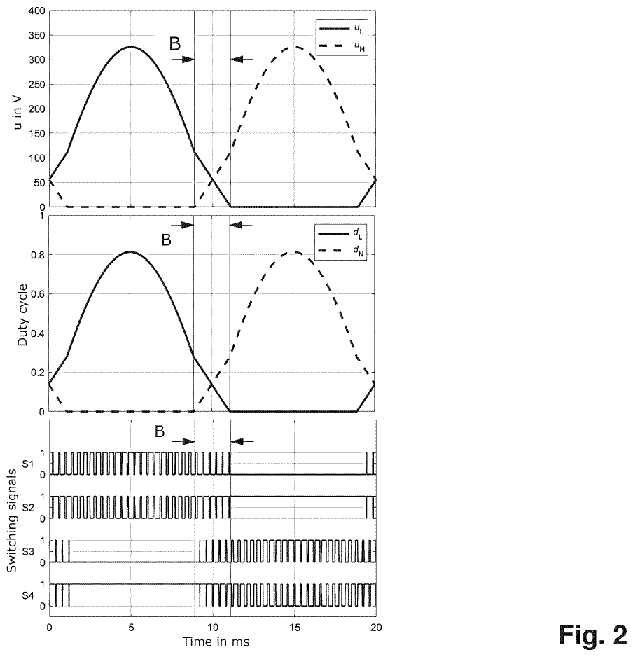

In FIG. 2, the top graph shows an example profile of the half-bridge voltages u_{L}, u_{N} when a method according to the application is used. The middle graph in FIG. 2 represents the duty cycles d_{L}, d_{N} used for this purpose for the respective half-bridges 20, 22. Here, d_{L} is the duty cycle for the first half-bridge 20 which results in the first half-bridge voltage u_{L}, and d_{N} is the duty cycle for the second half-bridge 22 which results in the second half-bridge voltage u_{N}. The bottom graph in FIG. 2 represents the switching signals used for the switches S1, S2 of the first half-bridge 20 and for the switches S3, S4 of the second half-bridge 22, wherein the value “1” means that the respective switch is switched on, and the value “0” means that the respective switch is open and therefore not switched off.

During unipolar clocking outside the transition region B, switches S1, S2 of the first half-bridge 20 are clocked complementary in the first half-wave, and switches S3, S4 of the second half-bridge are clocked complementary in the second half-wave. The first half-bridge 20 generates the first half-bridge voltage u_{L} which has a sinusoidal profile during the first half-wave of the output alternating voltage u_{AC} and is largely equal to zero in the second half-wave. The second half-bridge 22 generates the second half-bridge voltage u_{N} which is largely equal to zero during the first half-wave of the output alternating voltage u_{AC} and has a sinusoidal profile in the second half-wave. The profile of the duty cycles d_{L}, d_{N} corresponds to the profile of the respective half-bridge voltages u_{L}, u_{N}, respectively.

In a transition region B between the half-waves, the clocking is modified with respect to the otherwise exclusively unipolar clocking. In the transition region B, in one embodiment both half-bridges 20, 22 are clocked and therefore each generates a half-bridge voltage u_{L}, u_{N} not equal to zero. By means of the modified clocking, the profiles of the half-bridge voltages u_{L}, u_{N} are modified, as can be seen in the transition region B of the top graph of FIG. 2. For example, the slope of the half-bridge voltages u_{L}, u_{N} can be adapted in the transition region B. A reduction in the slope of the half-bridge voltages u_{L}, u_{N} in comparison to the slope of the half-bridge voltages u_{L}, u_{N} at the zero crossing with purely unipolar clocking is, for example, advantageous for damping any high leakage currents IA shown in FIG. 1.

The profile of the half-bridge voltages u_{L}, u_{N} for the first and second half-bridges are therefore changed in comparison with the otherwise half-wave sine wave of conventional exclusively unipolar clocking by the modification of the clocking in the transition region B.

In the example embodiment shown in FIG. 2, the half-bridge voltages u_{L}, u_{N} in the transition region B vary in opposite directions to each other and are mirror-symmetrical with respect to the time of the zero crossing of the alternating voltage u_{AC} at 10 ms. The shape of the profile of the half-bridge voltages u_{L}, u_{N} in the transition region B can, for example, be linear. Alternatively, the profile of the half-bridge voltages u_{L}, u_{N} can, for example, also correspond to the shape of the respective sine half-wave which, however, has been stretched over time so that in the example shown, it does not reach the value zero in the middle of the transition region B but rather at the edge of the transition region B.

In the illustrated example embodiment, the transition region B comprises a time span of +/−1 ms around the zero crossing of the alternating voltage. The clocking is modified in such a way, in one embodiment, that the profile of the leakage voltage UA at the zero crossing of the alternating voltage is as flat and steady as possible, i.e. has the lowest possible slope and is continuous.

The output-side alternating voltage u_{AC}, which is set to result between the phase conductor L and neutral conductor N, has a sinusoidal shape with the parameters of the alternating voltage grid: u_{AC}=Û·sin(ωt), where Û=325 V and f=50 Hz=ω/2π. To generate this alternating output voltage u_{AC}, suitable half-bridge voltages u_{L} and u_{N} can be determined as follows by breaking down the output-side alternating voltage u_{AC} into positive sequence components u₁, u₂ and a zero-sequence component u₀:

$${u}_{1} = 0.5 \cdot {u}_{AC} ,$$

$${u}_{2} = - 0.5 \cdot {u}_{A C}$$

$${u}_{0} = - min \int ( {u}_{1} , {u}_{2} )$$

$${u}_{L} = {u}_{1} + {u}_{0} , {u}_{N} = {u}_{2} + {u}_{0}$$

The respective duty cycle d_{L} and d_{N} results from taking into account the intermediate circuit voltage U_{DC}:

$${d}_{L} = \frac{{u}_{L}}{{U}_{D C}} , {d}_{N} = \frac{{u}_{N}}{{U}_{D C}}$$

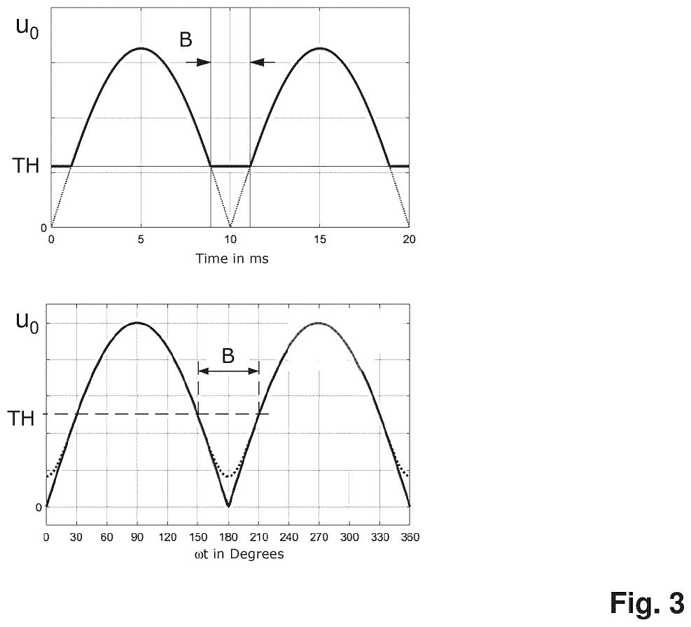

FIG. 3 shows, by way of example, possible sums of the absolute values of the half-bridge voltages u_{L}, u_{N} when applying the clocking according to the application in the transition region B. Due to the fundamental relationship u₀=u_{L}+u_{N} the profile of this sum voltage corresponds to the profile of the zero sequence component u₀.

In the example embodiment according to the top graph in FIG. 3, the sum of the absolute values of the half-bridge voltages u_{L}, u_{N} in the transition region B has a constant value. The constant value can, for example, correspond to a threshold value TH which is the sum of the absolute values of the half-bridge voltages u_{L}, u_{N} at the edges of transition region B. Within the transition region B, both half-bridges 20, 22 are clocked.

In the example embodiment shown the bottom graph in FIG. 3, the sum of the absolute values of the half-bridge voltages u_{L}, u_{N} in the transition region B has a shape that is approximated by a polynomial. For this approximation, the sum of the absolute values of the half-bridge voltages u_{L}, u_{N} within the transition region B, for example, can be described by the following polynomial: k₃(ωt)³+k₂(ωt)²+k₁ωt+k₀ for TH≥ωt≥0. TH is defined in this case as the threshold that the sum of the absolute values of the half-bridge voltages u_{L}, u_{N} assumes at the edges of transition region B.

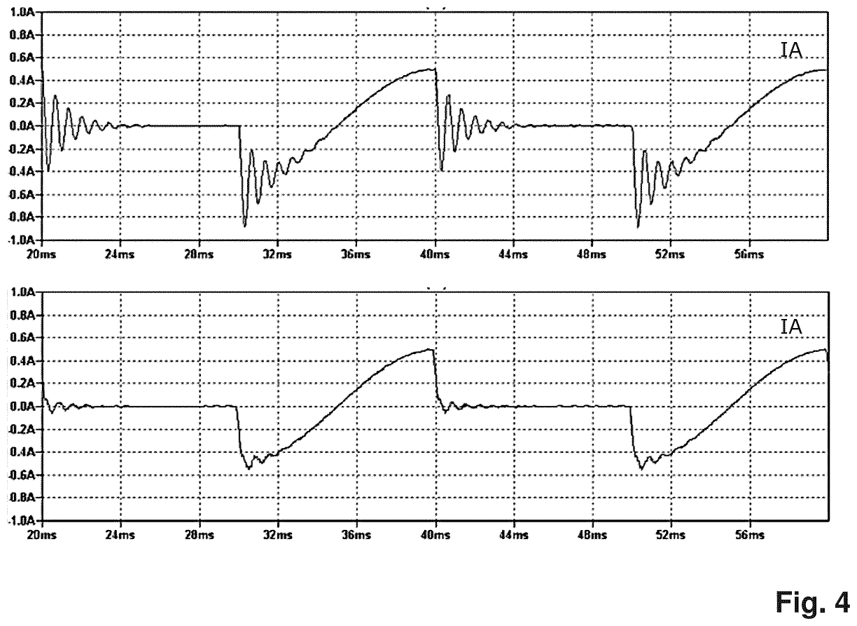

FIG. 4 shows by way of example resulting leakage currents IA for an example embodiment of a system with the inverter 10, PV generator 12 as the direct voltage source, and alternating voltage grid 14, as shown in FIG. 1.

The top graph of FIG. 4 shows a leakage current IA that results from operation with conventional purely unipolar clocking. Oscillations of the leakage current IA can be seen, which arise in the regions around the zero crossing of the alternating voltage u_{AC} of the alternating voltage grid 14 and have maxima with considerable amplitudes. For example, in the region with negative leakage current IA, fluctuations can occur which can lead to the triggering of safety mechanisms, for example, fault current monitoring, and therefore lead to the inverter switching off (e.g., via a control circuit that controls the switches S1-S4), and which also negatively affect the EMC behavior of the inverter. These oscillations are caused by the sudden change in the slope of the leakage voltage UA—corresponding to a large jump in the level of its leakage—at the zero crossing of the alternating voltage u_{AC}. Due to this change in slope, an oscillation within the resonant circuit comprising the PV leakage capacitor and common-mode impedances of the inverter filters is excited.

The bottom graph of FIG. 4 shows a damped leakage current IA which results when the inverter is operated using the method according to the application. Compared to the conventional situation in the top graph of FIG. 4, the amplitudes as well as the oscillations of the leakage current IA are significantly reduced.

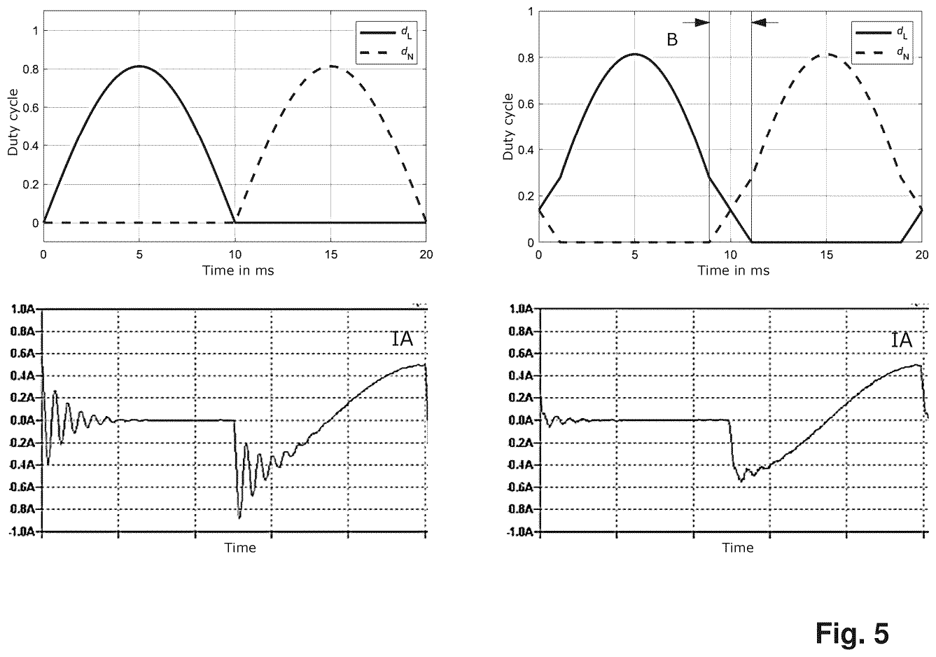

FIG. 5, by way of example, shows once more a comparison of conventional purely unipolar clocking (left) and modified clocking (right) with the resulting leakage currents IA.

The leakage capacitor 18 and the filter inductors of the inverter 10 form a resonant circuit via the ground potential 30. This resonant circuit is excited by the second half-bridge voltage u_{N} of the second half-bridge 22. When using purely unipolar clocking, as shown in the left-hand part of FIG. 5, the sudden change in the slope of u_{N} generates an equally sudden increase in the leakage voltage UA. This triggers, on the one hand, a rapid charge reversal of the leakage capacitor 18 and, on the other hand, excites a resonance of the resonant circuit consisting of the leakage capacitor and the common-mode inductor of the inverter 10, which in combination leads to an oscillating leakage current IA, which can also be called common-mode current. For example, the high absolute value of the leakage current IA at the maximum of the oscillation can also lead to saturation effects in the filter inductors of the inverter 10, which can have an in particular adverse effect on electromagnetic compatibility.

By means of the method according to this disclosure, the clocking in the transition region B around the zero crossing of the output-side alternating voltage u_{AC} is modified compared to exclusively unipolar clocking in such a way that the leakage current IA is damped. The modified clocking and the resulting leakage current IA are shown in the right-hand part of FIG. 5. For example, in the transition region B before and after the zero crossing, the first half-bridge 20 and the second half-bridge 22 are concurrently clocked in a pulse-width-modulated manner. As a result, the clocking profile of the two half-bridges deviates from the otherwise half-wave sinusoidal profile in that it has a shallower slope within the transition region than the underlying sinusoidal shape. This is associated with a profile of the zero-sequence component u₀ corresponding to the top graph in FIG. 3. As a result, the amplitude of the leakage current is significantly reduced, as shown in the bottom right graph of FIG. 5.

FIG. 6 shows the inverter 10 according to FIG. 1 in which the supply network 16 specifically comprises the inductors L1a, L1b which are arranged in the phase conductors L and N, and in which the phase conductors L and N are connected via capacitors C1a, C1b to the negative DC potential of the intermediate circuit 24 and the PV generator 12. Alternatively, the capacitors C1a, C1b can be arranged between the phase conductors L, N and the positive DC potential of the intermediate circuit 24, or between the phase conductors L, N and a center point of the intermediate circuit. The remaining supply network 16′ may comprise further filter elements for common-mode and/or differential-mode interference.

The transition region B is optimally chosen, in one embodiment, to be exactly as wide as half the period of a resonant oscillation of the resonant circuit comprising the leakage capacitor of the direct voltage source and the common-mode inductor of the inverter 10 in a worst-case scenario (worst-case analysis). The worst case in this regard is determined by the maximum expected leakage capacitance of the direct voltage sources that are to be connected to the inverter. In such worst case with both the amplitude and the period of the resonant oscillation being at their maximum, the resonances in the leakage current IA are suppressed as much as possible by setting the width of the transition region to correspond to half the resonant period of the resulting resonant circuit. With smaller leakage capacitances and unchanged width of the transition region, the oscillation is suppressed less effectively than actually possible; however, the overall amplitude of the leakage current through the leakage capacitor is then also lower so that the peak value of the leakage current is lower for smaller leakage capacitances than in the worst case as well. Alternatively, the width of the transition region can also be adjusted depending on the actual, e.g. currently determined, leakage capacitor. The width of the transition region is then set to half the period of the resonant oscillation of the actual resonant circuit. In the case of a PV generator as a direct voltage source with a varying leakage capacitance, e.g. depending on weather conditions, it can therefore be advantageous to adjust the width of the transition region in order to optimally damp the oscillations of the leakage current.

What is claimed is:

1. A method for operating an inverter, wherein the inverter comprises an H4 bridge circuit comprising a first half-bridge and a second half-bridge configured to convert an input-side direct voltage into an output-side alternating voltage, and wherein the inverter is further configured to exchange electrical power between a direct voltage source and an alternating voltage grid, wherein the direct voltage source has a variable potential relative to a ground potential via a leakage capacitance, wherein the method comprises:
unipolar pulse-width-modulated clocking of one of the first half-bridge and the second half-bridge in each half-wave of the output-side alternating voltage for half-wave generation of substantially sinusoidal half-bridge voltages (u_{L}, u_{N}), and
modifying the unipolar pulse-width-modulated clocking of the first half-bridge and the second half-bridge in a transition region around a zero crossing of the output-side alternating voltage, thereby damping a leakage current (IA) that flows through the leakage capacitance to the ground potential.

2. The method according to claim 1, wherein in the transition region before and after the zero crossing of the output-side alternating voltage, the first half-bridge and the second half-bridge are concurrently clocked in a pulse-width-modulated manner.

3. The method according to claim 1, wherein the half-bridge voltages (u_{L}, u_{N}) for the first half-bridge and the second half-bridge are changed with respect to a basic half-wave sine wave by the concurrent clocking in the transition region.

4. The method according to claim 3, wherein the half-bridge voltages (u_{L}, u_{N}) in the transition region run opposite to each other and are mirror-symmetrical with respect to a time of the zero crossing of the output-side alternating voltage.

5. The method according to claim 1, wherein the transition region comprises a time span of +/−0.02-1.0 ms around the zero crossing of the output-side alternating voltage.

6. The method according to claim 1, wherein the transition region comprises up to one tenth of a period of the output-side alternating voltage in the alternating voltage grid.

7. The method according to claim 1, wherein the unipolar pulse-width-modulated clocking of a respective half-wave in the transition region is modified such that the respective half-bridge voltage (u_{L}, u_{N}) has a profile whose slope is smaller than a slope of the ideal sinusoidal profile with exclusively unipolar clocking and which has a sinusoidal shape stretched over time or is linear.

8. The method according to claim 7, wherein a sum of absolute values of the half-bridge voltages (u_{L}, u_{N}) in the transition region comprises a constant value in the transition region.

9. The method according to claim 7, wherein a sum of absolute values of the half-bridge voltages (u_{L}, u_{N}) in the transition region comprises a shape that is approximated by a polynomial.

10. An inverter for supplying power of a direct voltage source to an alternating voltage grid, wherein the inverter has a control unit and an H4 bridge circuit having a first and a second half-bridge, wherein the control unit is configured to carry out a method comprising:
unipolar pulse-width-modulated clocking of one of the first half-bridge and the second half-bridge in each half-wave of an output-side alternating voltage for half-wave generation of substantially sinusoidal half-bridge voltages (u_{L}, u_{N}), and
modifying the unipolar pulse-width-modulated clocking of the first half-bridge and the second half-bridge in a transition region around a zero crossing of the output-side alternating voltage, thereby damping a leakage current (IA) that flows through a leakage capacitance of the direct voltage source to the ground potential.

11. A non-transitory computer readable media product which includes instructions that when executed by a control circuit cause the control circuit to perform a method, comprising:
unipolar pulse-width-modulated clocking of one of a first half-bridge and a second half-bridge of an H4 bridge circuit in each half-wave of an output-side alternating voltage for half-wave generation of substantially sinusoidal half-bridge voltages (u_{L}, u_{N}), and
modifying the unipolar pulse-width-modulated clocking of the first half-bridge and the second half-bridge in a transition region around a zero crossing of the output-side alternating voltage, thereby damping a leakage current (IA) that flows through a leakage capacitance to the ground potential.
